(19) United States
(12) Patent Application Publication
(10) Pub. No.: US 2026/0244706 A1
(43) Pub. Date: Aug. 20, 2026

(54) SYSTEMS AND METHODS FOR DETERMINING THE REAL-TIME ODDS OF A LEAD CHANGE OR TIE OCCURRING IN A CONTEST

(71) Applicant: GET THE LEAD LLC, Miami, FL (US)

(72) Inventor: Joshua Pardo, MIAMI, FL (US)

(73) Assignee: GET THE LEAD LLC, Miami, FL (US)

(21) Appl. No.: 18/838,993

(22) PCT Filed: Dec. 30, 2023
(86) PCT No.: PCT/US2023/086574

§ 371 Date: Aug. 15, 2024

Related U.S. Application Data
(60) Provisional application No. 63/532,835, filed on Aug. 15, 2023.

(51) Int. Cl. G06F 17/18

(52) U.S. Cl. CPC G06F 17/18

(57) ABSTRACT

The disclosed innovation introduces a real-time betting system that evaluates the probabilities of a team, player, or competitor leading, maintaining a lead, or resulting in a tie during dynamic-score competitions. Unlike conventional live betting structures, it offers continuous engagement by assessing probabilities at any moment, independent of the final outcome. The system employs mathematical algorithms within a computing framework, adapting biases based on predefined criteria and utilizing strength indicators for correlation with a team's strength. Notably, it calculates and mitigates biases, determining an average of probabilities. The primary objective is to perform these steps within predetermined time intervals, allowing for dynamic adjustments based on factors like pace of play. This computer-implemented method operates without human interaction, querying an external API for active competitions, processing real-time data, and delivering live odds to clients. The innovation transforms real-time betting, offering a dynamic and engaging wagering experience for users.

### CROSS-REFERENCE TO RELATED APPLICATIONS

This application is a non-provisional of, and claims priority to, U.S. Provisional Application No. 63/532,835, filed on Aug. 15, 2023, which is incorporated by reference herein in their entirety.

### TECHNICAL FIELD

The present invention generally relates to systems and methods for determining event probabilities and more specifically relates to systems and methods for determining the real-time odds of a lead change or tie occurring in a contest.

### BACKGROUND

For as long as there have been contests, humans have found a way to wager on the outcome. Many systems and methods are known in the art for facilitating the placing of wagers on a contest. These included determining a likely probability of a particular outcome for which the wagers are placed. Since the probability of an outcome is used to determine the payout of a wager, having a reliable method of calculating those probabilities is desired by those relying on them in placing their wagers.

Most betting systems provide odds for certain events of a contest. These odds are calculated to predict the likely probability of an outcome such as the final outcome of a game (eg: spread betting). However, there is no current system or method that determines probabilities for a wagering system for events at any point during a live contest. Specifically, there currently does not exist any system or method that determines probabilities of a tie or lead change at any point during a live contest. It is an unmet desire in the current art to always have an opportunity to place a wager on an event occurring, regardless of the score.

There exists, therefore, a need in the art for a system and related method that determines, in real time, the odds of a team, a player, or a competitor taking the lead over the other participants in a contest, at any given moment, during any competition in which the score (or equivalent success metric) fluctuates throughout the contest.

### SUMMARY

We disclose here a system and related method, as well as a computer program product, that determines, in real time, the odds of a team, a player, or a competitor taking the lead over the other participants in a contest or creating a tie, at any given moment, during any competition in which the score (or equivalent success metric) fluctuates throughout the contest.

The probabilities (odds) determined by the system are not limited by the outcome of the game, unlike all other live betting structures (eg.: spread betting, moneyline). In addition, the event for which a probability is determined can happen at any moment in the game or contest, rather than just the final score, keeping users (ultimately, bettors) engaged at all moments of the game. An object of the system and method is to determine whether there will be a tie or a lead change at any point in the competition. The probabilities of any of these three outcomes (keeping the lead, getting the lead, or tie) fluctuates in real-time as the score, time, and other factors change. This type of wagering does not exist today. The benefit of this is there is always an opportunity to place a wager on an event occurring regardless of the score. Whichever one of the three way bets are won the other two lose and require one to place a new bet to continue playing the game. In the occurrence where a 3-way bet is not possible then only one side will lose.

By way of overview and example (only), some embodiments of the present invention use process steps grouped by functional modules to determine the three way odds of a lead change, in other words, the probabilities of a tie, lead change, or keep the lead for a specified event in a competition. In some embodiments, a technological improvement in the field of determining real time wagering probabilities is achieved by performing method steps within a computing system that employ mathematical algorithms that take into account the determined probabilities of a tie, lead change, or keep the lead and considers a bias and changes said bias based off the +/− of a predetermined set of criteria. Embodiments of the invention then take into account the bias and uses strength indicators to find a correlative algorithm that connects a team's strength to their prospective probability outcomes. In embodiments, different formulas are employed for different circumstances that arise. For example, when the stronger team is leading at home versus away, or when the weaker team is leading at home versus away. Embodiments of the present invention employ formulas that take into consideration the existence of a bias, however, by calculating this bias the embodiments are able to minimize its effects. Finally, an average of results of the above equations may be employed to determine an average of the probabilities.

Yet another object of the present invention is to perform the prescribed method steps in real time—fully within a predetermined time interval. In embodiments, the predetermined time interval may be determined by such factors as the pace of play, every half-second, after a score, or some other predetermined value where the odds will reset at the end of the predetermined time interval and the method steps will be performed again.

Another embodiment of the present invention is a computer-implemented method of calculating, substantially in real time and without human interaction, the three-way odds of a lead change at any defined moment during a competition. An exemplary embodiment includes: detecting, by a computer querying an external API, if there is an active competition and, if an active competition is detected, then initiating, by the computer, a task to start processing real time data; receiving by the computer the real time data from the external API; establishing a predetermined time interval based upon the type of contest; performing certain method steps fully within said predetermined time interval; and pushing of live odds to clients, wherein the lead change is characterized as whether a participant in the competition, at any defined moment, takes the lead, keeps the lead, or a tie occurs.

Other embodiments of the present invention include a related system and computer program product comprising a non-transitory signal storage means for storing computer program instructions that, when executed on a processor, carry out any of the method steps disclosed and discussed herein.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a block diagram of exemplary components (modules) of a system configured to perform the method, according to an embodiment of the present invention;

FIG. 2 is a flow diagram of an exemplary process, according to an embodiment of the present invention;

FIG. 3 is an exemplary client/user view, according to an embodiment of the present invention; and

FIG. 4 is a simplified block diagram of an exemplary computing system, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in a flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention(s). Also, the present disclosure is not a listing of features of the invention(s) which must be present in all embodiments.

### Non-Limiting Definitions

The title of the present application and headings of sections provided in the present application are for convenience only, and are not to be taken as limiting the disclosure in any way.

The following non-limiting definitions are provided as a guide to interpreting the present invention:

The term “take the lead” or “taking the lead” means seizing the leading position from other participants in a competition. A participant's lead may be temporary or may last throughout the competition. The lead may also fluctuate, meaning that opponents may take over the leading position and lose it, multiple times, until a final winner is determined.

The term “keep the lead” or “keeping the lead” means maintaining the leading position in a competition without losing the leading position during the competition.

The term “tie” means to make or have an equal score with an opponent in a competition.

The term “competition” means a form of play, sport, race, contest, or game, especially one played according to rules and decided by skill, strength, or luck. In some embodiments in which the competition involves a sport or game, a competition may be football, hockey, basketball, baseball, golf, tennis, soccer, cricket, rugby, martial arts, boxing, swimming, skiing, snowboarding, horse racing, car racing, boat racing, cycling, wrestling, Olympic sports and medaling, for example. Competitions can also be unrelated to sports as in, for example, entertainment, financial markets, and politics-so long as a fluctuating score or other means of measuring achievement throughout the competition can yield a betting winner. Competitions are integrated into the embodiments in various ways. “Competition”, “game”, “contest” and other similar terms are used interchangeably, herein.

The term “betting interval” means a predetermined period of time within which a bet or wager can be placed by a user, either before or during a competition. A betting interval can be the time before the competition begins, when the user bets on which participant will take the initial lead, how many lead changes or ties there will be during the entire competition, or which team will ultimately prevail. After the competition begins and one participant has taken the lead or there is a tie, each betting interval spans the time until the lead changes or there is a tie. Upon a lead change or tie, bets are paid and users can place new bets on the next interval until the competition ends. Exceptions may occur. For example, in football, a touchdown may or may not result in a lead change or a tie. However, the scoring team, still in possession of the ball, has an opportunity to score an extra point by a kick or two extra points by other means. The betting interval does not end until all these opportunities are played out.

The term “Event” means an interval of time during a competition when a specific act by one or more participants during that interval concludes with either a lead change or a tie. For example, in basketball, an Event may be the interval during which one team scores and ties or takes the lead. Outside the world of sports, such as in entertainment, financial markets, or politics, the embodiments can be used to determine odds for taking the lead, keeping the lead, or ties and to set corresponding bets, for example, in reality competitions on television, on awards shows such as the Oscars, in electoral races, or financial markets. For instance, the Event in a reality competition may be that week's show, which ends with a certain number of points or advantages for certain participants. In a basketball game, an Event may include the number of total ties (over/under), number of total lead changes (over/under), and who will score first. In an awards show, an Event may be each category in which each participant is nominated for an award. In an election, the Event may be demarcated by each hour or other time interval of the counting of votes, the outcome of each tranche of votes that are counted, the tally of Republicans versus Democrats elected to Congress, or the counting of electoral college votes for president. In the financial markets, the Event may be which stock will gain or lose the most value within a certain interval. For the live part of the competition there is get the lead, tie, and keep the lead along with the real time total number of ties and lead changes (over/under). Lastly, when the game is tied there is a bet on who will regain the lead and then the total number of lead changes and ties (over/under).

The term “scoring event” means any Event where a team scores a point, or some equivalent metric.

The term “raw event” means the data representing a moment in time during the competition. This includes, but is not limited to, the current score, time elapsed, away team, home team, team strength, and player strength information.

The term “nonevent” refers to an interval of time during a competition when a specific act by one or more participants during that interval does not conclude with either a lead change or a tie, but rather one participant retains the lead during the remainder of the competition.

The term “bet” or “wager” is a risk, usually a sum of money, against another, such as a bookmaker, based on the outcome of a future Event. Such Event, as defined herein, includes the fluctuation of points or other measurement of performance in a game or competition. Non-monetary items also may be the subject of a “bet” or “wager” such as points, coupons, free or upgraded tickets, or anything else that can be quantified for a “bet” or “wager”. A “bet” or “wager” can be active for a certain amount of time, such as an Event as defined herein. A “bet” or “wager” can be integrated into the embodiments in various ways.

The term “user” refers to a person who bets or wagers, more commonly known as a customer or client. In certain embodiments, the “user” may be the direct beneficiary of the output of the disclosed system or method, such as a sports-betting Bookmaker that utilizes the odds determined by the invention to accept bets.

The term “Bookmaker” means a physical or online establishment that accepts bets on the outcome of Events.

The term “book” means a system that enables a user with a computer to interact, according to set of both implicit and explicit rules, in an electronically powered domain, for the purpose of placing bets on the outcome of an Event. A “book” can be integrated into embodiments in various ways.

The term “no action” means a wager in which no money is lost or won and the original bet amount is either refunded or carries over to the next Event for which a new bet would otherwise need to be placed to continue the user's participation in the bet. “No action” can be integrated into the embodiments in various ways.

The term “sides” or “side” means the competing participants in an Event.

The term “Casinos” means public rooms or buildings where traditional gambling games such as slot machines, blackjack, roulette, etc. . . . are played. Similarly, the term “Racino” means a building complex or grounds with a racetrack and gambling facilities for playing casino games. “Casino” and “Racino” can be integrated into the embodiments in various ways.

The term “Payout” refers to the total amount of money the bookmaker pays the user if the user wins the wager, including both the user's original wager and the user's profit. To calculate a money line payout, the odds of the participant's winning are multiplied by the user's bet amount. The resulting number is the user's potential payout, not including the original bet.

The term “product” means any machine, manufacture, and/or composition of matter, unless expressly specified otherwise. A “product” may also be a “computer program product” as disclosed herein.

The term “process” means any process, algorithm, method or the like, unless expressly specified otherwise.

Each process (whether called a method, algorithm, or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g.,, 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. The term “determining” does not imply certainty or absolute precision, and therefore “determining” can include estimating, extrapolating, predicting, guessing and the like. The term “determining” does not imply that mathematical processing must be performed, and does not imply that numerical methods must be used, and does not imply that an algorithm or process is used. The term “determining” does not imply that any particular device must be used. For example, a computer need not necessarily perform the determining.

The terms “real time” and “real time process” means one that executes within a predefined time interval that is tied to a physical condition relevant to, or within, the system. As related to the present system and method, the predetermined time interval may be determined by factors such as, but not limited to, the pace of play, every half-second, after a score, or some other predetermined value-relevant to the contest or competition for which the process is running-where the odds will reset at the end of the predetermined time interval and the process will be performed again.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

### Variables

The invention disclosed herein utilizes various gathered and derived values in the determination of probabilities according to embodiments. The following definitions of these such variables are presented as follows:

The “velocity” (static or bias velocity) is the score difference from the differing strength of the participants. Velocity is determined by assessing factors including the scoring differences and isolates the effects of participant strength differences.

The “diffusion coefficient”, as known in the fields of chemistry and physics, quantifies the rate at which particles diffuse, or separate, throughout a medium. The diffusion coefficient is applied here in a novel manner to characterize the diffusion of scoring in relation to time within a contest.

The “score delta” is the absolute value of the score difference and relates to the score differential between two or more participants during a contest or competition.

The “leading team strength”, is a historical plus/minus of the stronger team. This factor is determined by averaging the plus/minus of a team over a number of games. For example, if a team wins the first game by two, their plus/minus is 2. If the next game they lose by 6, the plus minus would be −4. However, since this is an average, the average historical plus minus is −2.

The “Péclet number”, is known in the field of continuum mechanics. The Péclet number is a class of dimensionless numbers relevant in the study of transport phenomena in a continuum. Here, the Péclet number is used in a novel manner to describe, or characterize, as a dimensionless number, the rate at which the play diffuses based upon the velocity, leading team strength, weaker team strength, and the diffusion coefficient.

### Computing

It will be readily apparent to one of ordinary skill in the art that the various processes described herein may be implemented by, e.g., appropriately programmed general purpose computers, special purpose computers, and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, or one or more scripts.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein.

Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### Determining the Three-Way Odds of a Lead Change

By way of example and not limitation, the following disclosure discusses the invention in the context of calculating, in real time, the odds of a team, or a player, taking the lead, keeping the lead, or having a tie during a competition in which the score fluctuates throughout the contest. For ease of disclosure, we discuss in the context of a basketball game.

In the context of a basketball game, there are two participant teams and each team is composed of individual players. Historical performance data is available on each team, as well as, each individual player. Furthermore, data may be collected and processed during the course of a game, as the game is played live. Basketball is a contest in which the score at any moment may reflect a tie, a lead change, or a team keeping the lead.

Users bet on whether a team, or player, will take the lead, keep the lead, or tie an opponent. The outcome of each bet is determined at the finality of each Event during the competition. Events are defined for each game to delineate the closure of a bet, the determination of a winning bet for that specific Event, and the opening of a new bet that allows users to wager whether the now-current leader will keep its lead, the opponent will take the lead, or the competitors will tie at the end of the next Event.

As discussed, above, in a basketball game, there are the number of total ties (over/under), number of total lead changes (over/under), and who will score first. For the live part of the competition there is get the lead, tie, and keep the lead along with the real-time total number of ties and lead changes (over/under). Lastly, when the game is tied, there is a bet on who will regain the lead and then the total number of lead changes and ties (over/under).

It will be noted that not all sports or contests have the option for 3-way betting. For example, any sport where one team or player cannot take the lead without first tying the opponent who is in the lead such as hockey, soccer, lacrosse, etc. . . . While there is still a 3-way betting system, however, the tie no longer cancels out the get the lead bet, since a tie is required for the team to get the lead.

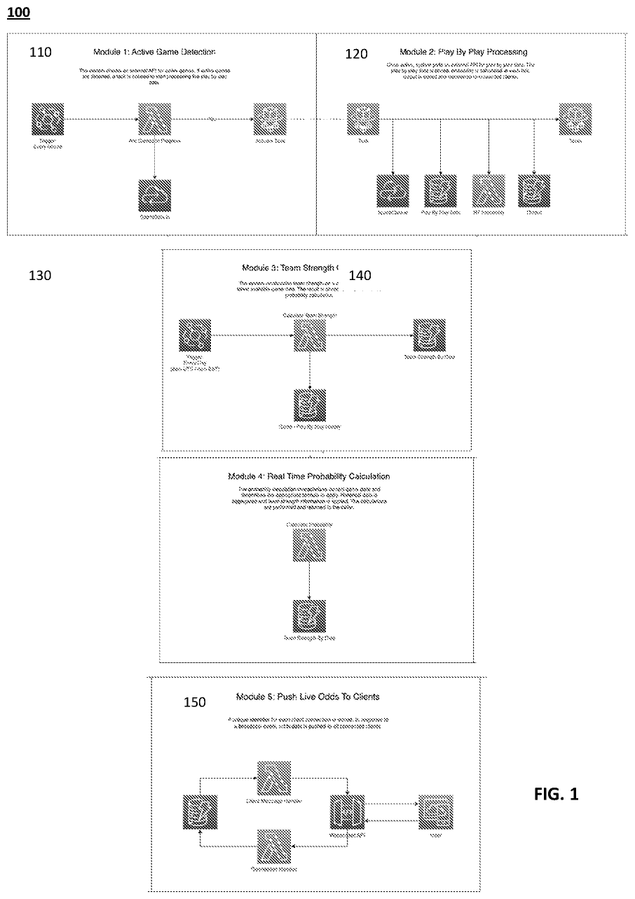

In an exemplary embodiment, and referring to FIG. 1, the invention 100 includes a plurality of modules, or engines, that perform prescribed functions and are interconnected in order to perform the desired function of determining in real time the odds of a team, or a player, taking the lead, keeping the lead, or having a tie during a competition in which the score fluctuates throughout the contest. These modules include: a competition detection module 110; a play by play processing module 120; a participant strength calculation module 130; a real time probability calculation module 140; and a push to client module 150.

In an exemplary process for determining in real-time the three-way odds of an Event in a Competition, the Competition Detection Module 110 queries an external API and searches for games that are occurring in a specified sport. When an active game is found, the Competition Detection Module 110 initiates a task to start processing live play-by-play data (via the Play by Play Processing Module 120), as well as, for the other modules (such as the team strength module 130) to start running and gather predetermined data for the game. Prior to game start, predetermined odds are determined in anticipation of the match-up (knowing the schedule and historical data for the participants). This includes probabilities associated with the number of ties and lead changes that will occur and the odds of which team will score first, These predetermined odds, such as the number of ties and lead change probabilities, are based on data from the participant strength calculation module 130, the diffusion coefficient, the scoring velocity, the pace of play and average points per scoring event. The first score probability is based on the scoring percentages, the diffusion coefficient, the scoring velocity, the team strengths, the proportion of successful first scores, and the proportion of successful first possessions.

Once the game has begun, the first lead bet is closed and the system waits for the first lead to be created. Once the match starts, the play by play processing module 120 is initialized and after the first lead is taken the probabilities for the tie, lead change, and get the lead are determined (via the Real Time Probability Calculation Module 140) based on the participant strength calculation module 130 data points and formulas, the diffusion coefficient, the scoring velocity, the absolute value score difference, time remaining, number of ties that have occurred, number of lead changes that have occurred, and lastly the connection between the on-court team strength and the real time probabilities. The real-time number of lead changes and ties that will occur is calculated using the participant strength calculation module 130 and different data points collected in the play by play processing module 120. These data points include the number of ties, number of lead changes, the absolute value score difference, diffusion coefficient, scoring velocity, time remaining, pace of play, and the average points per scoring event.

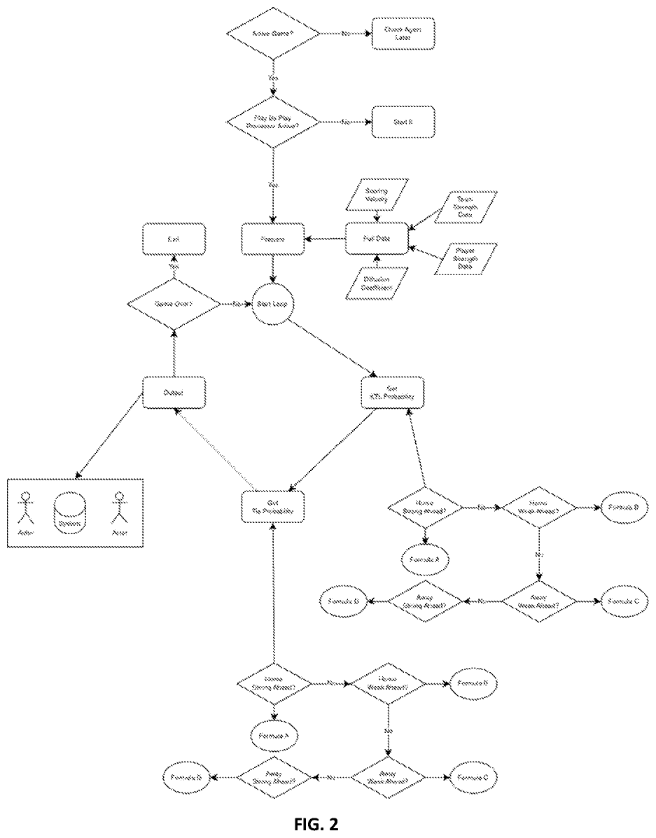

Embodiments of the invention follow a decision tree in order to determine which of a plurality of formulas to use for a particular situation. An exemplary decision tree is shown in FIG. 2. In a three-way odds game, some situations may include: 1) home team stronger (in strength) and leading, 2) home team weaker and leading, 3) away team stronger and leading, and 4) away team weaker and leading. These situations would be evaluated for each of a “keep the lead” and “tie” probability determination. Each of these situations determines which formula to use and the weights associated with each variable involved in the formula chosen.

When the game is tied there are separate formulas for the number of ties, number of lead changes, and which team will score next (or regain the lead). These formulas remove the absolute value score differential from the equation and rely on the same and added statistics as the equations before. The added statistics include percentage of successful scores, proportion of successful retaking of the lead, and whether it is the first possession or not in the sequence. The older statistics used are the diffusion coefficient, the scoring velocity, time remaining, and the on-court team strength of each team (along with a different team strength formula). These odds are each set to be in a two-way system betting either the over/under on the number of ties and lead changes and which team will score next.

### Scheduler

Although not specifically disclosed here for compactness of disclosure, a person having ordinary skill in the art of computing and computing systems will readily recognize the need and implementation of a “scheduler” or a “cron utility.” The cron utility is a job scheduler that allows scheduling of repetitive tasks at predefined times, dates, or intervals. By way of example, and not limitation, a scheduler can invoke the Competition Detection Module 110 to check for new games every one minute, or for the Team Strength Module 130 to determine team strength values every day during a league season at 5:00 am.

### Competition Detection Module 110

This module interfaces with at least one external application programming interface (API) to check for actively occurring competitions (games). If active games are detected, a task is initiated for the Play by Play Processing Module 120 to start processing live play by play data.

On receipt of an invoking command from the scheduler, this module queries at least one external API or database to determine whether or not there are games currently in progress and, if so, the module triggers the Play by Play Processing Module 120 to begin processing play by play events. The required inputs to this module are criteria describing the service to be created if an active game is detected. This includes where to store information about the created services, the name of the subsequent service to be created, targets for the dependencies of this service, and the locations to store intermediate and finalized outputs. In embodiments, the information is stored in a database table of running services that keeps track of which games are currently being monitored. In this way, only one service per game is maintained and avoids duplicates.

Upon invocation, the module requests data from a third party API via, for example, HTTP request. The result of this request is a Boolean field indicating true if there are games in progress; otherwise false. The module then determines if other instances of the same service are currently active or pending creation; if so, no action is taken. Once the module has verified all required checks, it will proceed by triggering the initiation of the Play by Play Processing Module 120. The Play by Play Processing Module 120 will orchestrate the collection and processing of steps remaining to determine the probability output.

The Competition Detection Module 110 is invoked by the Scheduler and invokes the Play by Play Processing Module 120.

### Play by Play Processing Module 120

Once active this module polls an external API, or other such service that was queried for active games, for play by play data.

This module orchestrates the collection and processing of play by play data for active games. The module is instantiated externally by the Competition Detection Module 110 and passes the play by play data to the Real Time Probability Calculation Module 140. If the Competition Detection Module 110 detects the start of a new game, an API call triggers the creation of a new task in the Play by Play Processing Module 120. The module will interpret the events of the game in real time and interface with other supporting modules in the system. Each raw event the module processes is stored in a long term storage database for future reference.

Once activated, this module instantiates a procedure that will cycle at a predefined configurable interval until exited. For example, in the context of a basketball game with a 24 second shot clock, the interval may be set for 15 seconds. The first step of the procedure pulls play by play data from a third party API. The returned play by play data will represent each event that has occurred in the game over the last one minute, for example. The play by play data is stored in memory for future reference. The module performs a comparison between the new events received from the third party API and events previously recorded into memory to determine a delta of which events have not yet been processed and stored. This ensures that no event is processed more than once and improves the accuracy of the system. The raw event data from the third party API is transformed into a flattened data structure and stored in a database table for long term persistence. The raw play by play data is passed by the module to the Probability Module 140 for concurrent processing.

The Play By Play Processing Module 120 then determines whether it should remain active to process future plays. This check queries the third party API that will return a flag indicating whether or not the game has ended. If the game has ended, the interval is cleared and the module exists. Immediately prior to exiting, the module will delete its own task record from the task database table. This data informs the active game detection module whether a task currently exists to process events from a specific game. If the game is still active, the interval repeats at the predefined configurable interval.

This module is invoked by the Competition Detection Module 110 and invokes one or more of the Probability Processing Module 140 and the Client Broadcast Module 150.

### Participant Strength Calculation Module 130

This module determines team strength on a pre-defined basis, such as daily, using the latest available game data. The result is stored for reference in the probability calculation.

This module determines strength data for each team in the league or participant in the contest. This module is triggered, or invoked, in a scheduled manner via the Scheduler. For the use case of a basketball season, the trigger can be defined for this module to repeat once per day, for example. The procedure begins by calling a third party API to retrieve team statistical data for all teams for the last season and current season. A team strength value is determined based upon the retrieved statistical data. Particular emphasis is placed on more recent games but historical trends are factored in as well. The output is stored in a database table for long term persistence. The team strength data is used by the Probability Module 140 and ultimately determines which formula that module will use to determine the probabilities.

This module is invoked by the Scheduler. While it does not invoke another module, the data determined by this module is stored in a database to be retrieved by the Probability Module 140.

### Real-Time Probability Calculation Module (“Probability Module”) 140

This module takes inputs from other modules, characterizes current game state, and determines the appropriate formula to apply for the purpose of calculating probabilities of Event outcomes. (See, for example, the decision loops of FIG. 2.) Historical data is aggregated from play by play data captured and stored from the previous seasons of play by the Team Strength Module 130. The Probability Module 140 retrieves the team strength data from a database. The probabilities of Event outcomes are determined and are made available to be retrieved by the Client Broadcast Module 150.

The Probability Module 140 is configured to receive data from the Play by Play Module 120 describing a pre-defined time interval in a game and determines an output (or a plurality of outputs) characterizing the probability of various events occurring. The required inputs may include, but are not limited to, data elements representing home team, away team, current quarter, time remaining in the quarter, home team score, away team score, latest scoring event, and latest possession update. Upon invocation, the module begins by aggregating additional required elements from outside sources including external modules (such as the Team Strength Module 130) and database systems.

The module will begin by requesting the latest available team strength data for the participating home and away teams from the Team Strength Module 130. As discussed above, the Team Strength Module 130 determines the team strengths for all active teams in the league on a pre-defined interval and stores the results in a database table. The returned strength is then used to characterize the relationships between the teams by determining whether the stronger team, or weaker team has home court advantage, and vice-versa. This information is utilized by the Probability Module 140 when determining which formula to apply in a probability determination.

Database queries are performed by the module to gather additional information about the context of the current request including the number of scoring events, number of lead changes, and the number of ties that have occurred thus far in the game. The next series of database queries collect the diffusion coefficient and bias velocity. These values are determined by the Team Strength Module 130 on a predefined interval using aggregations of historical league game data. The retrieved values for velocity and diffusion coefficient are combined with the current absolute score differential and the elapsed time in the game to determine a scaled lead size. The final preparation step involves calculating the Péclet number for the dataset using the bias velocity, diffusion coefficient, and normalized team strengths.

The computed and gathered variables are passed by the module to a set of individual functions responsible for calculating the tie and keep the lead probability. These functions will accept the inputs defined above and choose a formula (see FIG. 2). The choice is based on which team is currently ahead, their strength relative to their opponent, and whether or not that team has home court advantage. The module will apply the chosen formula and return the derived value to the caller function. The output is a value between 0 and 1.

The process steps in this module are performed once for the tie probability calculation and once for the keep the lead probability calculation. (See the “start loop” in FIG. 2.) Subsequently, the get the lead probability can be determined simply as the inverse of the tie and keep the lead probabilities combined. These values are run through a weighted conversion algorithm to provide a representation in the American odds format, although other odds formats may also be provided.

The computed and gathered variables are also passed by the module to a series of functions responsible for calculating estimated total ties, estimated total lead changes, real-time total ties, and real-time total lead changes. These functions accept the inputs defined above, apply an algorithmic implementation of a mathematical formula, and output a positive number indicating the designated value. The inputs, intermediary values, and outputs are aggregated into a message object structure, persisted into a database table for long term storage, and returned to the function caller.

This module is invoked by the Play-by-Play Module 120. The data from this module 140 is output back to the Play by Play Module 120, which gathers the data, stores it, and then sends the output data to the Client Broadcast Module 150.

### Client Broadcast Module 150

A unique identifier for each client connection is stored. In response to a broadcast event, odds data is pushed to all connected clients.

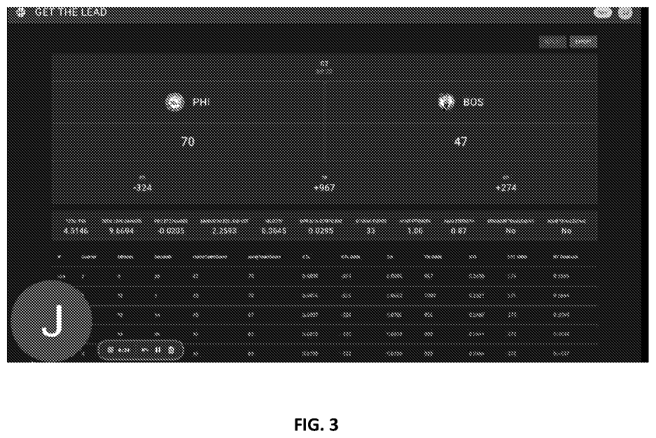

This module monitors subscribed clients and broadcasts the Probability Module output (from the Play by Play Module) accordingly. The first component is used to track connection and disconnection events from the client. A connection event is triggered when a client accesses the system via a user interface, such as, but not limited to, a web application. In embodiments, the web application is the graphical interface that a person would access via their web browser to view the real time results of the probability calculations. (See FIG. 3) When accessed by a user, a page displaying the games scheduled for that day is shown. The application, running in a browser, establishes, for example, a websocket connection with a server. The server transmits the probability data, as it determined in real time, to the connected user's browser. The application renders the state updates to the screen indicating the changing odds associated with these probabilities as the game progresses.

The module processes that event and stores it with a unique value used to identify the client. This data is persisted in a database table along with the current date and time. A disconnect event is triggered when the client closes the web application or the connection is otherwise disrupted (reconnects are triggered automatically). The module processes that disconnect event and removes the corresponding unique identifier for that client from the database table. The second component is used to retrieve the unique identifiers from the database table and broadcast a message to those subscribed clients. The play by play processing module will invoke the client broadcast module with the results of the probability calculation. This allows the calculated probabilities to be broadcast to the user interface in real time.

### Exemplary System

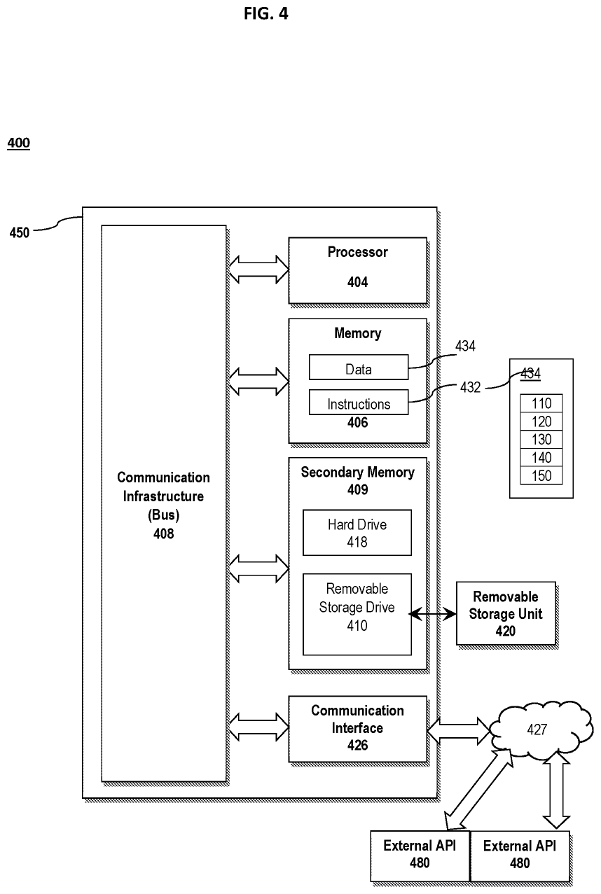

FIG. 4 illustrates a block diagram of an exemplary system for determining in real time the odds of a team, or a player, taking the lead, keeping the lead, or having a tie during a competition in which the score fluctuates throughout the contest, according to an embodiment of the present invention. The system 400 shown in FIG. 4 is only one example of a suitable system and is not intended to limit the scope of use or functionality of embodiments of the present invention described above. The system 400 is operational with numerous other general purpose or special purpose computing system environments or configurations. Examples of well-known computing systems, environments, and/or configurations that may be suitable for use with the information processing system 400 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, clusters, and distributed cloud computing environments that include any of the above systems or devices, and the like.

The system 400 may be described in the general context of computer-executable instructions, being executed by a computer system. The system 400 may be practiced in various computing environments such as conventional and distributed computing environments where tasks are performed by remote processing devices that are linked through a communications network. In a distributed computing environment, program modules may be located in both local and remote computer system storage media including memory storage devices.

Referring again to FIG. 4, system 400 includes the backend server 450. In some embodiments, backend server 450 can be embodied as a general-purpose computing device. The components of backend server 450 can include, but are not limited to, one or more processor devices or processing units 404, a system memory 406, and a bus 408 that couples various system components including the system memory 406 to the processor 404.

The bus 408 represents one or more of any of several types of bus structures, including a memory bus or memory controller, a peripheral bus, an accelerated graphics port, and a processor or local bus using any of a variety of bus architectures.

The system memory 406 can also include computer system readable media in the form of volatile memory, such as random access memory (RAM) and/or cache memory. The backend server 450 can further include other removable/non-removable, volatile/non-volatile computer system storage media 409, 410, 418, 420. By way of example only, a storage system 409 can be provided for reading from and writing to a non-removable or removable, non-volatile media such as one or more solid state disks and/or magnetic media (typically called a “hard drive” 418). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 408 by one or more data media interfaces. The memory 406 can include at least one program product 432 embodying a set of program modules 434 that are configured to carry out one or more features and/or functions of the present invention e.g., described with reference to FIGS. 1-3. Referring again to FIG. 4, program/utility 432, having a set of program modules 434, may be stored in memory 406 by way of example, and not limitation, as well as an operating system, one or more application programs, other program modules, and program data. Generally, program modules may include routines, programs, objects, components, logic, data structures, and so on that perform particular tasks or implement particular abstract data types. Each of the operating system, one or more application programs, other program modules, and program data or some combination thereof, may include an implementation of a networking environment. In some embodiments, program modules 434 are configured to carry out one or more functions and/or methodologies of embodiments of the present invention.

The backend server 450 can also communicate with one or more external devices that enable interaction with the backend server 450; and/or any devices (e.g., network card, modem, etc.) that enable communication with one or more other computing devices. A few (non-limiting) examples of such devices include: a keyboard, a pointing device, a display presenting system output (see FIG. 3), etc.; one or more devices that enable a user to interact with the backend server 450; and/or any devices (e.g., network card, modem, etc.) that enable the backend server 450 to communicate with one or more other computing devices. Such communication can occur via I/O interfaces. In some embodiments, the backend server 450 can communicate with one or more networks 427 such as a local area network (LAN), a general wide area network (WAN), and/or a public network (e.g., the Internet) via network adapter 426, enabling the system 400 to access one or more external API 480. As depicted, the network adapter 426 communicates with the other components of the backend server 450 via the bus 408. Other hardware and/or software components can also be used in conjunction with the backend server 450.

As will be appreciated by one skilled in the art, aspects of the present invention may be embodied as a system, method, or computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, although not limited to, an electronic, magnetic, optical, electromagnetic, infrared, or semiconductor system, apparatus, or device, or any suitable combination of the foregoing. In the context of this disclosure, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, although not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a non-transitory computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, although do not preclude the presence or addition of one or more other features, integers, steps, operations, elements, components, and/or groups thereof.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated.

1. A method of calculating, substantially in real time and without human interaction, the three-way odds of a lead change at any defined moment during a competition, the method comprising:
detecting if there is an active competition;
receiving play by play data;
processing play by play data;
calculating team strength;
calculating real time probability; and
pushing of live odds to clients,
wherein the lead change is characterized as whether a participant in the competition, at the any defined moment, takes the lead, keeps the lead, or a tie occurs.

2. A system for calculating, substantially in real time and without human interaction, the odds of a lead change at any defined moment during a competition, the system comprising:
a competition detection module;
a play by play processing module;
a participant strength calculation module;
a real time probability calculation module; and
a push to client module.

3. The system of claim 2, where the competition detection module queries an external API and, if an active competition is found, initiates a task to the play by play processing module to start processing live play by play data.

4. The system of claim 2, where the competition detection module initiates the other modules and, upon initiation by the competition detection module, the initiated modules gather predetermined data.

5. The system of claim 2, where the real time probability calculation module determines the probabilities for the tie, lead change, and get the lead.

6. The system of claim 2, where the live play by play data include data types chosen from the following: number of ties, number of lead changes, the absolute value score difference, diffusion coefficient, scoring velocity, time remaining, pace of play, and the average points per scoring event.

7. The system of claim 2, where the play by play processing module orchestrates the collection and processing of steps remaining to determine the probability output.

8. The system of claim 2, where the play by play processing module passes the play by play data to the real time probability calculation module.

9. The system of claim 2, where the play by play processing module stores event data in a long term storage database for future reference.

10. The system of claim 2, where the play by play processing module invokes one or more of the probability processing module and the push to client module.

11. The system of claim 2, where the participant strength calculation module determines strength data and makes it available to other modules for their processing.

12. The system of claim 2, where the real time probability calculation module takes inputs from other modules, characterizes current game state, and determines the appropriate formula to apply for the purpose of calculating probabilities of Event outcomes.

13. The system of claim 2, where the real time probability module is invoked by the Play-by-Play Module, the data from the real time probability module is output back to the Play by Play Module, which gathers the data, stores it, and then sends the output data to the Client Broadcast Module.

14. The system of claim 2, where the system is further configured to generate and store a unique identifier for each client connection.

15. The system of claim 14, where the client broadcast module pushes odds data to each client connection based on each unique client identifier.

16. A computer-implemented method of calculating, substantially in real time and without human interaction, the three-way odds of a lead change at any defined moment during a competition, the method comprising:
detecting, by a specially-programmed computer querying an external API, if there is an active competition and, if an active competition is detected, then initiating, by the specially-programmed computer, a task to start processing real time data;
receiving by the specially-programmed computer the real time data from the external API;
establishing a predetermined time interval based upon the type of competition;
calculating said odds;
performing the calculating fully within said predetermined time interval; and
pushing of said odds to clients,
wherein the lead change is characterized as whether a participant in the competition, at any defined moment, takes the lead, keeps the lead, or a tie occurs.

17. A computer program product configured to run on a special-purpose computer to determine, substantially in real time and without human interaction, the three-way odds of a lead change at any defined moment during a competition, the computer program product comprising:
detecting, by the special-purpose computer querying an external API, if there is an active competition and, if an active competition is detected, then initiating, by the specially-programmed computer, a task to start processing real time data;
receiving the real time data from the external API;
establishing a predetermined time interval based upon the type of competition;
calculating said odds;
performing the calculating fully within said predetermined time interval; and
pushing of said odds to clients,
wherein the lead change is characterized as whether a participant in the competition, at any defined moment, takes the lead, keeps the lead, or a tie occurs.
